(19) United States
(12) Patent Application Publication
(10) Pub. No.: US 2025/0259769 A1
(43) Pub. Date: Aug. 14, 2025

(54) NESTED GROMMET

(71) Applicant: BRIDGEPORT FITTINGS, LLC, Stratford, CT (US)

(72) Inventors: Christopher DECESARE, Naugatuck, CT (US); Eric CERASALE, Southington, CT (US); Western ZICKEFOOSE, Shelton, CT (US)

(21) Appl. No.: 19/051,928

(22) Filed: Feb. 12, 2025

Related U.S. Application Data
(60) Provisional application No. 63/552,406, filed on Feb. 12, 2024.

(51) Int. Cl. H01B 17/58

(52) U.S. Cl. CPC H01B 17/583

(57) ABSTRACT

Electrical fittings utilize nested grommets that include an outer grommet portion that include a bore extending from a first circumferential end to second circumferential end, the first circumferential end having a larger surface circumference than the second circumferential end. Further, the first circumferential end has a larger surface circumference than the second circumferential end such that the outer grommet portion forms an outer surface that forms a tapered frustoconical sleeve. The nested grommets also include an inner grommet portion having a body sized to at least partially nest within the bore of the outer grommet portion.

### CROSS REFERENCE TO RELATED APPLICATIONS

This application claims priority to and benefit of U.S. Provisional Patent Application No. 63/552,406 filed Feb. 12, 2024, entitled NESTED GROMMET, the entirety of which is hereby expressly incorporated by reference. In addition, this application expressly incorporates by reference in its entirety the contents disclosed by U.S. Pat. No. 6,737,584 issued May 18, 2004, entitled Electrical Cable Connector.

### FIELD OF THE INVENTION

This invention generally relates to sealing grommets for use in rain-tight, water-resistant and/or moisture-tight electrical fittings, and more particularly to a nested grommet configurable for receipt and sealing of a wide range of electrical cable sizes.

### BACKGROUND

Grommets for use in sealing electrical fittings from rain or other moisture grommet may incorporate a tapered outer shape that matches a corresponding inner taper of an electrical fitting and a through-hole formed in the grommet through which an electrical cable may pass through. During use, the grommet is compressed as a gland nut is tightened onto the electrical fitting thereby sealing the outer taper of the grommet against the inner taper of the electrical fitting and the through-hole against the electrical cable. However, electrical cables come in a large range of diameters, and the sealing of the grommet is dependent upon the electrical cable being within the correct range of diameters for the particular grommet. If the diameter of the electrical cable is too small, the grommet cannot be adequately compressed sufficient enough to effectively seal against the electrical cable, and the if the diameter of the electrical cable is too large it will not pass through the through-hole of the grommet. Thus, a need exists for improved grommets to adequately function with a wide variety of electrical cable sizes.

### SUMMARY

Shortcomings of the prior art are overcome, and additional advantages are provided, through the provision of an electrical fitting that includes fitting body comprising a hollow cavity extending from a first threaded end to a second threaded end, the first threaded end having a larger circumference than the second threaded end, the hollow cavity including a sloped opening extending along at least a portion of a length of the hollow cavity that is tapered to narrow a diameter of the hollow cavity in a direction towards the second threaded end. The electrical fitting also includes an inner sleeve member that comprises a tubular housing, the tubular housing including one or more spring arm members directed towards an interior of the inner sleeve member, the inner sleeve member being retained within the hollow cavity of the fitting body. Further, the electrical fitting includes a nested grommet comprising an inner grommet portion and an outer grommet portion, the inner grommet portion including a body configured to at least partially nest within at least a portion of a bore of the outer grommet portion. The electrical fitting also includes a fitting nut configured to be threaded onto the first threaded end. Threading the fitting nut about the first threaded end causes the nested grommet to interface with the fitting nut and the sloped opening to form a seal.

Also disclosed herein is a nested grommet that includes an outer grommet portion comprising a bore extending from a first circumferential end to second circumferential end, the first circumferential end having a larger surface circumference than the second circumferential end, the first circumferential end having a larger surface circumference than the second circumferential end such that the outer grommet portion forms an outer surface that forms a tapered frustoconical sleeve. The nested grommet portion includes a body sized to at least partially nest within the bore of the outer grommet portion.

Additional features and advantages are realized through the concepts described herein.

### BRIEF DESCRIPTION

Aspects described herein are particularly pointed out and distinctly claimed as examples in the claims at the conclusion of the specification. The foregoing and other objects, features, and advantages of the disclosure are apparent from the following detailed description taken in conjunction with the accompanying drawings in which:

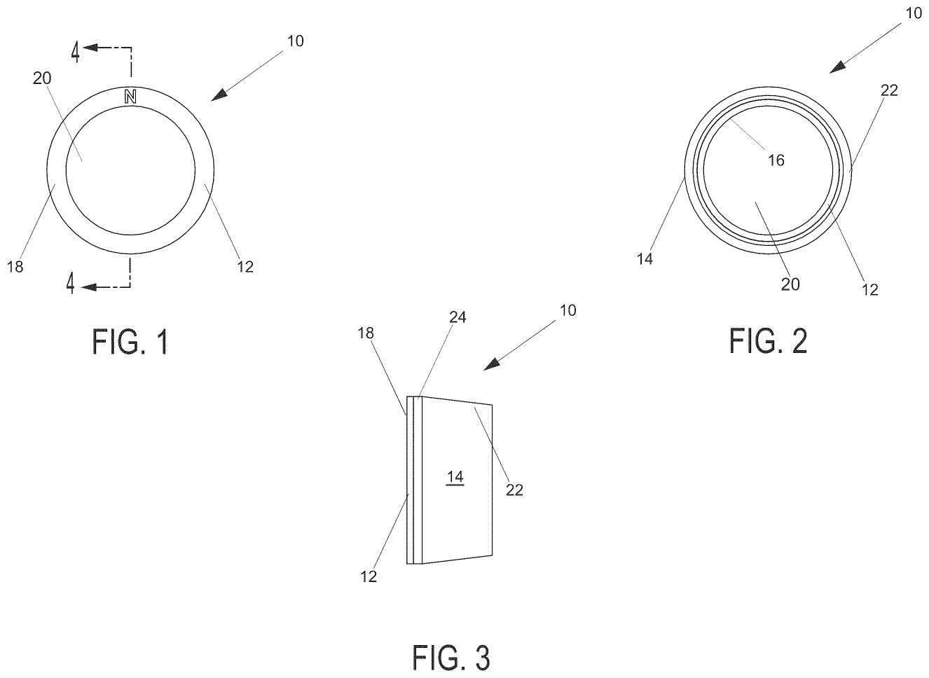

FIG. 1 is a front view of an exemplary nested grommet according to an aspect of the invention;

FIG. 2 is a side view of the exemplary nested grommet according to an aspect of the invention;

FIG. 3 is a rear view of the exemplary nested grommet according to an aspect of the invention;

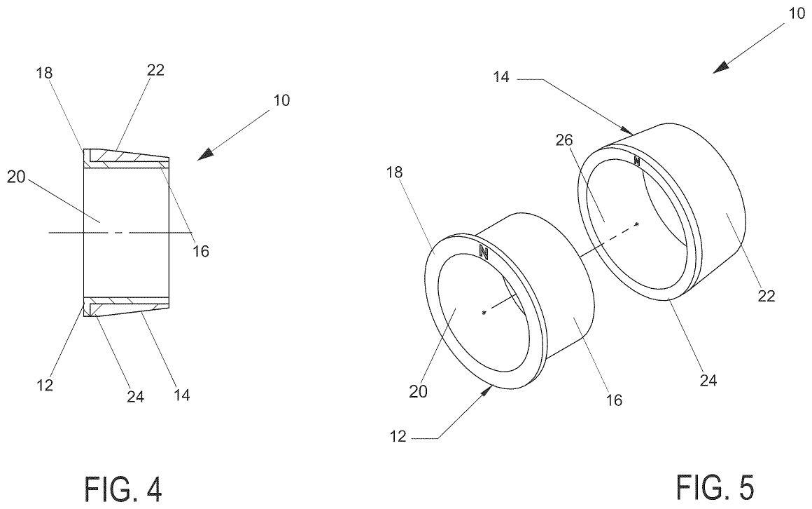

FIG. 4 is a cross-sectional view taken along line 4-4 from FIG. 1;

FIG. 5 is an exploded view of the exemplary nested grommet according to an aspect of the invention;

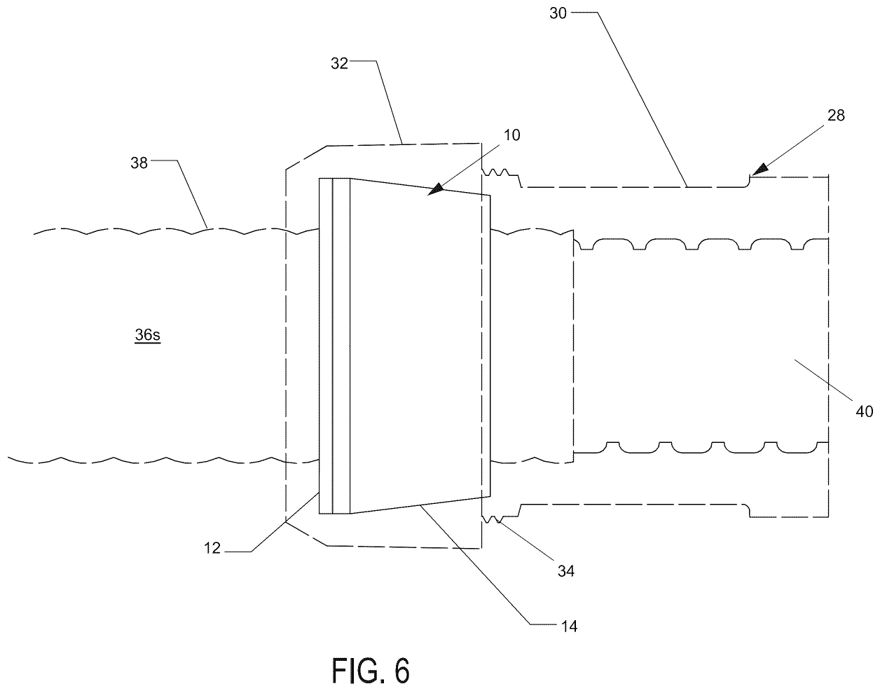

FIG. 6 is a transparent side view of the exemplary nested grommet in use in an exemplary fitting for jacketed metal-clad cable;

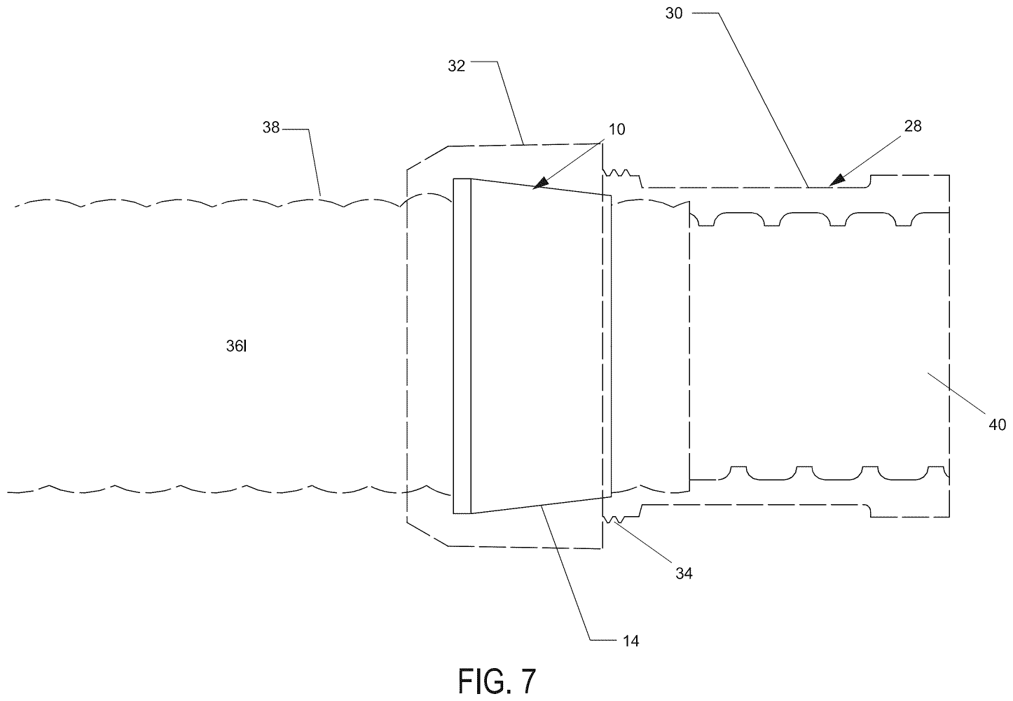

FIG. 7 is a transparent side view of the outer portion of the exemplary nested grommet in use in an exemplary fitting for jacketed metal-clad cable;

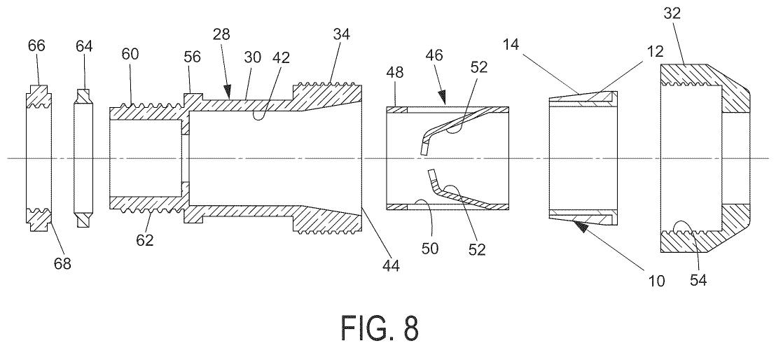

FIG. 8 is an exploded cross-sectional view of the exemplary nested grommet in an exemplary fitting for jacketed metal-clad cable;

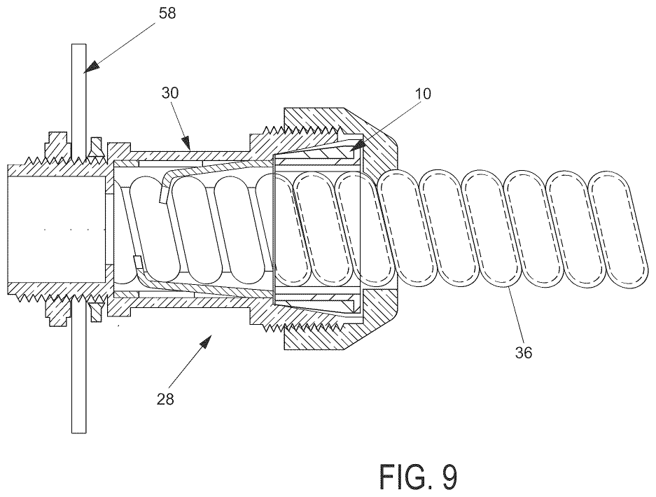

FIG. 9 is a cross-sectional side view of the exemplary nested grommet in use in an exemplary fitting for jacketed metal-clad cable mounted in a convention junction box and/or outlet box;

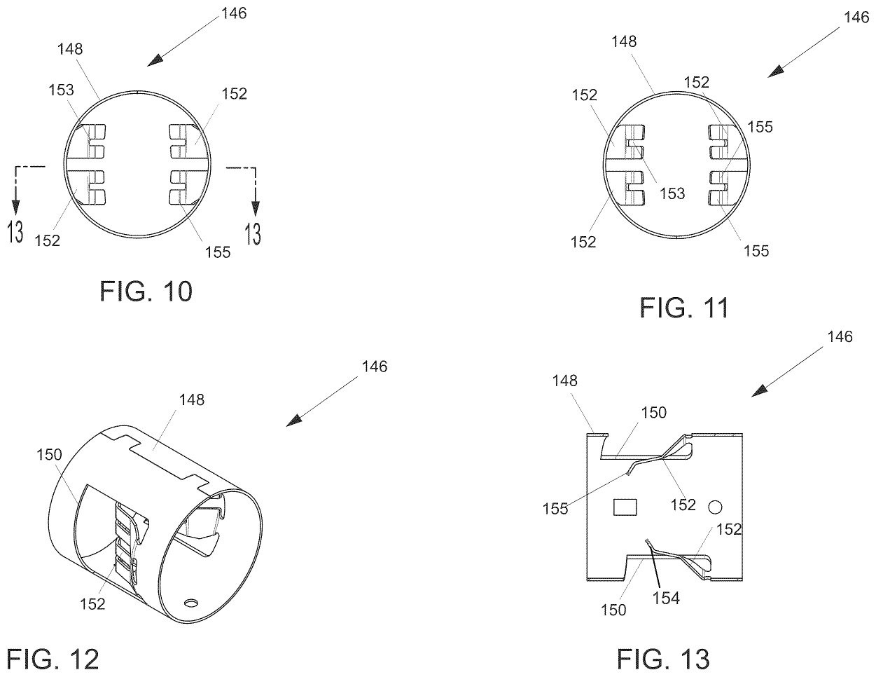

FIG. 10 is a front view of an exemplary inner sleeve member according to an aspect of the invention;

FIG. 11 is a rear view of the exemplary inner sleeve member according to an aspect of the invention;

FIG. 12 is a perspective view of the exemplary inner sleeve member according to an aspect of the invention;

FIG. 13 is a cross-sectional view taken along line 13-13 from FIG. 10;

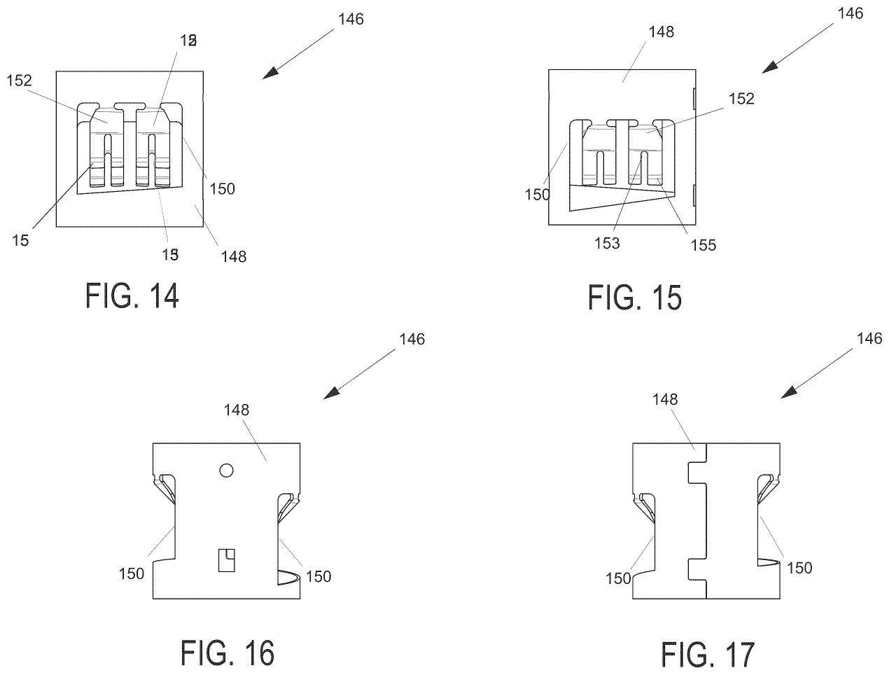

FIG. 14 is a side view of the exemplary inner sleeve member according to an aspect of the invention;

FIG. 15 is a side view of the exemplary inner sleeve member according to an aspect of the invention;

FIG. 16 is a bottom view of the exemplary inner sleeve member according to an aspect of the invention;

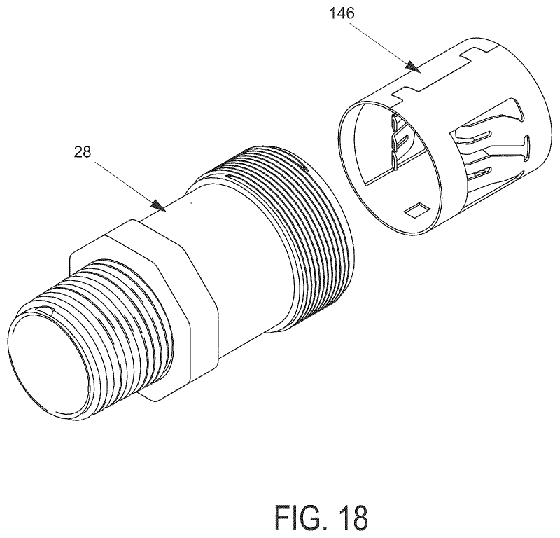

FIG. 17 is a top view of the exemplary inner sleeve member according to an aspect of the invention;

FIG. 18 is an exploded perspective view of the exemplary inner sleeve member in combination with an exemplary electrical fitting; and

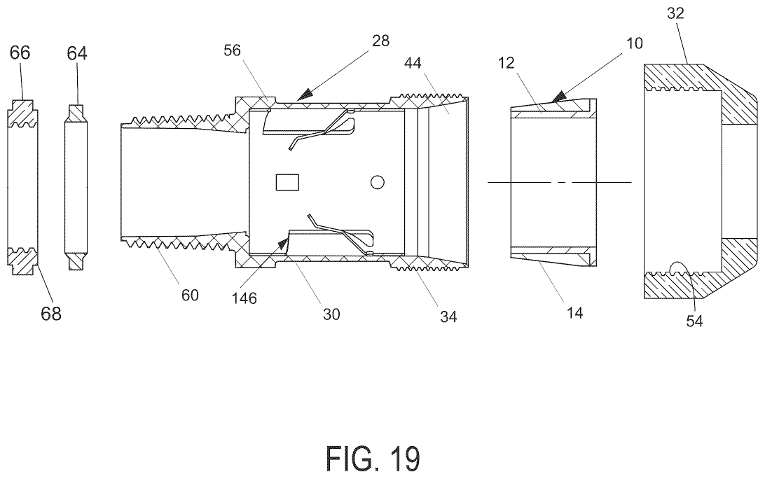

FIG. 19 is an exploded cross-sectional view of the exemplary nested grommet and exemplary inner sleeve member in an exemplary fitting for jacketed metal-clad cable.

### DETAILED DESCRIPTION

Aspects of the present invention and certain features, advantages, and details thereof are explained more fully below with reference to the non-limiting examples illustrated in the accompanying drawings. It is to be understood that the disclosed embodiments are merely illustrative of the present invention and the invention may take various forms. Further, the figures are not necessarily drawn to scale, as some features may be exaggerated to show details of particular components. Thus, specific structural and functional details illustrated herein are not to be interpreted as limiting, but merely as a representative basis for teaching one skilled in the art to employ the present invention.

Descriptions of well-known processing techniques, systems, components, etc. are omitted to avoid obscuring the invention with well-known details. It should be understood that the detailed description and the specific examples, while indicating aspects of the invention, are given by way of illustration only, and not by way of limitation. Various substitutions, modifications, additions, and/or arrangements, within the spirit and/or scope of the underlying inventive concepts will be apparent to those skilled in the art from this disclosure. Note further that numerous inventive aspects and features are disclosed herein, and unless inconsistent, each disclosed aspect or feature is combinable with any other disclosed aspect or feature as desired for a particular embodiment of the concepts disclosed herein.

The specification may include references to “one embodiment,” “an embodiment,” “various embodiments,” “one or more embodiments,” etc. may indicate that the embodiment(s) described may include a particular feature, structure or characteristic, but every embodiment may not necessarily include the particular feature, structure, or characteristic. In some cases, such phrases are not necessarily referencing the same embodiment. When a particular feature, structure, or characteristic is described in connection with an embodiment, such description can be combined with features, structures, or characteristics described in connection with other embodiments, regardless of whether such combinations are explicitly described. Thus, unless described or implied as exclusive alternatives, features throughout the drawings and descriptions should be taken as cumulative, such that features expressly associated with some particular embodiments can be combined with other embodiments.

Unless defined otherwise, technical and scientific terms used herein have the same meaning as commonly understood to one of ordinary skill in the art to which the presently disclosed subject matter pertains.

The exemplary embodiments are provided so that this disclosure will be both thorough and complete and will fully convey the scope of the invention and enable one of ordinary skill in the art to make, use, and practice the invention.

The terms “couple,” “coupled,” “couples,” “coupling,” “fixed,” “attached to”, and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

In addition, as used herein, the terms “about,” “approximately,” or “substantially” for any numerical values or ranges indicate a suitable dimensional tolerance that allows the device, part, or collection of components to function for its intended purpose as described herein.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Certain electrical products increasingly have requirements for larger cable sizes. For example, solar power walls having increasingly larger power requirements, which leads to larger cable requirements. Thus, a need exists to be able to accommodate varying cable sizes. Accordingly, disclosed herein are electrical fitting devices, systems, and methods that can effectively reduce the number of electrical fitting varieties needed to fit various cable sizes, such as jacketed metal clad cables, by using nested grommet configuration. For example, a grommet seal may incorporate a nested grommet configuration that includes an internal grommet and an external grommet, the internal grommet being sized and shaped or otherwise configured to “nest” or otherwise fit within the external grommet. The internal grommet may be removable from the external grommet to accommodate larger electrical cable sizes than can be accommodated by the combination of the internal grommet and external grommet. The internal grommet and the external grommet are sized and shaped or otherwise configured such that the space between the internal grommet and the external grommet effectively forms a rain-tight and/or moisture-tight seal between one another when combined in order to protect the cables that pass through the grommet seal. In particular, the external grommet may include a bore having cylindrical diameter that is greater than a respective cylindrical diameter of the inner grommet such that the inner grommet snugly fits inside of the external grommet. The inner grommet may incorporate a circumferential flange extending around one end thereof, and a through-hole formed therein. The circumferential flange may inhibit or otherwise prevent the internal grommet from slipping through the outer grommet and also provides a sealing mechanism to assist with the rain-tight and/or moisture-tight seal. In some embodiments, the outer grommet may include a tapered sleeve, an integral ring at one end of the tapered sleeve, and a bore formed in the tapered sleeve. Specifically, the bore of the outer grommet is sized and shaped or otherwise configured so as to receive the cylindrical body of the inner grommet, and a jacketed metal clad cable that passes through the through-hole of the inner grommet. When the inner grommet is removed, the bore of the outer grommet is sufficiently large to accommodate larger sizes of jacketed metal clad cables that would not be accommodated when the inner grommet is present. Included the inner grommet allows for a tighter seal around the jacketed metal clad cables that have a narrower diameter since using solely the external grommet without the inner grommet would created an undesirable gap or loose seal, which can lead to the introduction of moisture or rain in external-use environments.

The electrical fitting may incorporate a fitting to grip onto the metal jacket portion of a metal jacketed cable. The metal jacket may be surrounded by a polyvinyl chloride (PVC) coating. In order to utilize the electrical fitting, a practitioner may strip off a portion (e.g., ⅞ of an inch-1 inch) of the PVC coating to expose the metal jacket and insert it into the electrical fitting. The fitting includes an inner sleeve member that comprises a locking device that has a set of tangs or spring arm retainers that interface with the metal jacket to grip to the metal jacket cable in order to hold the cable in place and also to provide an electrical connection in order to pass a resistance test. When the metal jacketed cable is inserted through the electrical fitting, a “click” sound will be made when the tangs or spring arm retainers engage the metal jacket. The grommet provides a seal between the fitting nut and the sloped opening of an electrical fitting. The grommet inhibits introduction of liquid between the fitting and the fitting nut, and the seal needs to pass a one-hour rain test where there is no ingress of water into the fitting after one hour of simulated rain. The grommet itself is sealed around the outer PVC coating that has not be stripped from the metal jacket.

In some embodiments, there may be multiple nested bushings for the grommet so that there may be more than simply an inner grommet and an outer grommet. For example, there may be an intermediately sized and shaped to surround the circumference of the inner grommet while still fitting within the outer grommet.

FIGS. 1-5 illustrate an exemplary nested grommet that is sized and shaped or otherwise configured to be utilized in conjunction with an electrical fitting to provide a rain-tight and/or moisture-tight seal when suitably sized electrical cables are inserted into such electrical fittings. The nested grommet is generally indicated by reference numeral 10 and includes an inner grommet 12 and an outer grommet 14. The outer grommet 14 may be sized and shaped or otherwise configured/dimensioned to receive at least a portion of the inner grommet 12 within the outer grommet 14. The inner grommet 12 may be formed from a substantially cylindrical body 16 and a circumferential flange 18 positioned at one end of the cylindrical body 16. In other embodiments, the body of the inner grommet 12 may alternatively have a tapered body that fits within a taped outer grommet 14. A through-hole 20 may be formed in the cylindrical body 16 to allow for a passageway through the inner grommet 12. The outer grommet 14 may include a tapered sleeve 22 and an integral ring 24 positioned at one end of the tapered sleeve 22. The outer grommet 14 may further include a bore 26 formed therein and dimensioned to receive the cylindrical body 16 of the inner grommet 12. Further, when the inner grommet 12 is removed, the bore 26 would fit a jacketed metal clad cable that has a larger diameter. The end of the tapered sleeve 22 adjacent to the integral ring 24 has an outer diameter substantially the same as the largest outer diameter of the tapered sleeve 22. The outer diameter of the tapered sleeve 22 decreases towards the other end of the outer grommet 14 so that the tapered sleeve 22 has a substantially frustoconical outer shape. The tapered sleeve 22 may drives the compression feature of the nested grommet 10 in order to provide the water resistant seal. The diameter of the bore 26 remains the same or at least substantially the same along the length of the outer grommet 14. The diameter of the bore 26 is such that the cylindrical body 16 of the inner grommet 12 can be slidingly received and removed from the outer grommet 14. Preferably, the diameter of the bore 26 is only larger than the outer diameter of the cylindrical body 16 so that the inner grommet 12 can be removed and inserted into the outer grommet 14 without significant deformation and/or difficulty, but not so much larger that a gap is formed between the inner grommet 12 and outer grommet 14.

Referring now to FIGS. 6 and 7, the general use of the exemplary nested grommet 10 incorporated within an electrical fitting 28 will be discussed. The electrical fitting 28 may include a fitting body 30 and a fitting nut 32 configured to be threaded onto a threaded end 34 of the fitting body 30. The nested grommet 10 may be positioned between the fitting body 30 and fitting nut 32 so that the nested grommet 10 is retained within the electrical fitting 28 when the fitting nut 32 is threaded onto the fitting body 30. The electrical fitting 28 may be of the type for use with jacketed metal-clad (JMC) cable. JMC cable may be formed from metal, such as aluminum or steel, helically wrapped around electrical conductors and coated with a water-impermeable or water-resistant jacket, such as polyvinyl chloride (PVC). As shown for example in FIG. 6, when a JMC cable 36s has an outer diameter smaller than the through-hole 20 of the inner grommet 12, both the inner grommet 12 and the outer grommet 14 of the nested grommet 10 may be used in connection with the electrical fitting 28. The jacket 38 of the JMC cable 36s may be sealed against the cylindrical body 16 of the inner grommet 12 as the fitting nut 32 is threaded onto the fitting body 30 and compresses the nested grommet 10 against the electrical fitting 28. A portion of the jacket 38 of the JMC cable 36s may be removed from the metal wrapping 40 so that the jacket 38 does not extend into the electrical fitting 28. The compression of the nested grommet 10 by the fitting nut 32 also acts to seal the cylindrical body 16 of inner grommet 12 against the tapered sleeve 22 of the outer grommet 14, to prevent and/or inhibit passage of moisture between the inner gromet 12 and the outer grommet 14. The circumferential flange 18 of the inner grommet 12 may also form a seal against the integral ring 24 of the outer grommet 14 as a result of compression by the fitting nut 32. As shown for example in FIG. 7, when a JMC cable 361 has an outer diameter larger than the through-hole 20 of the inner grommet 12, but smaller than the bore 26 of the outer grommet 14, the inner grommet 12 may be removed from its nested arrangement with the outer grommet 14 to allow passage of the JMC cable 361 through the nested grommet 10 and rain-tight and/or moisture-tight coupling of the JMC cable 361 to the electrical fitting 28. The jacket 38 of the JMC cable 361 may be sealed against the tapered sleeve 22 of the outer grommet 14 as the fitting nut 32 is threated onto the fitting body 30 and compresses the nested grommet 10 against the electrical fitting 28. A portion of the jacket 38 of the JMC cable 361 may be removed from the metal wrapping 40 so that the jacket 38 does not extend into the electrical fitting 28.

Referring now to FIGS. 8 and 9, an exemplary use of the nested grommet 10 in connection with the electrical fitting 28 and JMC cable 36 will be discussed in greater detail. In addition to the component discussed above, the electrical fitting 28 may further include an interior cavity 42 formed within the fitting body 30, and a sloped opening 44 formed in the threaded end 34 of the electrical fitting 28. The interior cavity 42 is configured and dimensioned to receive an inner sleeve member 46 within the electrical fitting 28. The inner sleeve member 46 may be press-fit into the interior cavity 42 so that the inner sleeve member 46 is integral with the electrical fitting 28 and cannot be pulled out without substantial force. The inner sleeve member 46 may have any suitable construction as the exemplary inner sleeve members discussed in U.S. Pat. No. 6,737,584. For example, the inner sleeve member 46 may be formed from a tubular housing 48 having one or more openings 50 formed therein, and at least a pair of spring arm retainers 52 extending from the tubular housing 48 towards the interior of the inner sleeve member 46. The spring arm retainers 52 are configured to allow passage of the JMC cable 36 in one direction but retain the JMC cable 36 from pulling out from the electrical fitting 28 in the opposition direction. The spring arm retainers 52 may be configured to engage with the metal wrapping 40 of the JMC cable 36. The sloped opening 44 of the electrical fitting 28 is dimensioned and configured to be complementary with the tapered sleeve 22 of the nested grommet 10. The slope, curve and/or taper of the sloped opening 44 is configured to compress the diameter of the nested grommet 10 as the fitting nut 32 is threaded onto the threaded end 34 of the electrical fitting 28. The fitting nut 32 may have fitting nut threads 54 to engage with the threaded end 34. As the fitting nut 32 is tightened onto the electrical fitting 28 the space between the fitting nut 32 and sloped opening 44 decreases which urges the nested grommet 10 into and/or further into the sloped opening 44. As a result of the tapered sleeve 22 engaging with the reducing slope, curve and/or taper of the sloped opening 44 the outer diameter of the tapered sleeve 22 is compressed and reduced. This compression is transferred to the inner sleeve 12 thereby also reducing the diameter of the through-hole 20 if the inner sleeve 12 is still within the nested grommet 10, or the compression reduces the diameter of the bore 26 if the inner sleeve 12 has been removed from the nested grommet 10. The decrease in diameter of the through-hole 20 or the bore 26 creates a rain-tight and/or moisture-tight seal between the nested grommet 10 and the jacket 38 of the JMC cable 36. The compression of the tapered sleeve 22 by the sloped opening 44 also creates a rain-tight and/or moisture-tight seal between the nested grommet 10 and the electrical fitting 28. Since the inner grommet 12 can be removed, the nested grommet 10 provides for a larger range of JMC cable 36 sizes that can be used with the electrical fitting 28 and still create a rain-tight and/or moisture-tight seal. The electrical fitting 28 may also include a flange 56 to allow mounting of the electrical fitting 28 in an opening of a junction box and/or outlet box 58. Extending from the end the electrical fitting 28 opposite the threaded end 34 may be coupling tube 60 having threads 62 formed therein and configured to be at least partially received within the junction box/outlet box 58. A gasket 64 that forms a sealing ring that may be positioned between a junction box knockout (not shown) of the junction box/outlet box 58, and a lock nut 66 having lock nut threads 68 corresponding to the threads 62 of the coupling tube 60 may be used to secure the electrical fitting 28 to the junction box/outlet box 58 and compress the gasket 64 to create a rain-tight and/or moisture-tight seal between the flange 56 and the junction box/outlet box 58.

In some embodiments, the fitting 28 may incorporate a multiplicity of sloped openings 44 that are each configured to receive a respective JMC cable 36, and each sloped opening 44 may have a corresponding nested grommet 10 that is used to seal the JMC cable 36 with the sloped opening. In such embodiments, each respective JMC cable 36 may have differing diameters and, as a result, the inner grommet 12 may be removed from the outer grommet 14 for some of the JMC cables, but in for other JMC cables the inner grommet 12 may still be nested within the outer grommet 14. Further, for such implementations, there may be different nested bushing options where some nested grommets have only the inner grommet 12 and the outer grommet 14, but other sloped openings 44 may include an intermediately sized grommet (i.e., three grommets) or multiple intermediate grommets with even more bushings nested one within another (e.g., four or more grommets). The intermediate grommets may be configured similar to inner grommet 12 with differing cylindrical diameters. In such embodiments, the grommets may be color coded depending upon the number of bushings nested within one another. For example, a grommet that includes only an inner grommet 12 and an outer grommet 14 may be labeled or otherwise have one color and a grommet that includes an intermediate grommet may be labeled or otherwise have a different color.

Referring now to FIGS. 10-19, an alternative embodiment of an inner sleeve member 146 for use with the electrical fitting 28 and nested grommet 10 is illustrated. The inner sleeve member 146 may include a tubular housing 148 and one or more openings 150 formed in the tubular housing 148. The tubular housing 148 is dimensioned to be press-fit into the electrical fitting 28, and not be able to be pulled out of the electrical fitting 28 by forces below the required pull-out requirements of the electrical fitting 28. The inner sleeve member 146 may also include one or more pairs of spring arm members 152 extending from the tubular housing 148 in a direction towards the interior of the inner sleeve member 146. Each of the spring arm members 152 may include a slot 153 formed therein, and the slot 153 defines a pair of grip fingers 155 positioned at an end of each spring arm member 152. The slot 153 and pair of grip fingers 155 provide for increased flexibility of the spring arm member 152 to reduce the amount of force needed to engage the JMC cable 36 with the spring arm members 152. In some embodiments, there may be more than two grip fingers 155 for each spring arm members 152. Otherwise, the inner sleeve member 146 functions the same as the inner sleeve member 46 discussed above. In addition, as depicted by FIG. 13, one spring arm member 154 may have a staggered depth within the tubular housing 148 relative the other spring arm member 152. As depicted, spring arm member 152 may extend further in depth (e.g., due to a staggered positioning relative the tubular housing 148) relative spring arm member 154. Because the JMC cable 36 may have helical convolutions, the offset depth allows for the JMC cable 36 to be unscrewed if it needs to be removed from the electrical connector because the spring arm member 152 is positioned to fit within the helical channel at one portion of the JMC cable 36 that is a different depth from the portion of the helical channel interfacing with the spring arm member 154 as depicted by FIG. 9.

The nested grommet 10 may be formed from a compressible, but resilient, material such as neoprene or other non-metallic material (e.g., a hard rubber material). Preferably, the nested grommet 10 can be formed from a material that does not significantly degrade when exposed to the elements and/or temperature fluctuations. In some embodiments, the inner grommet 12 may be made from a different material from the outer grommet 14 that has a different hardness or grip in order to provide a tighter seal.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises,” “has,” “includes,” or “contains” one or more steps or elements possesses those one or more steps or elements but is not limited to possessing only those one or more steps or elements. Likewise, a step of a method or an element of a device that “comprises,” “has,” “includes,” or “contains” one or more features possesses those one or more features but is not limited to possessing only those one or more features. Furthermore, a device or structure that is configured in a certain way is configured in at least that way but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to explain the principles of one or more aspects of the invention and the practical application thereof, and to enable others of ordinary skill in the art to understand one or more aspects of the invention for various embodiments with various modifications as are suited to the particular use contemplated.

What is claimed is:

1. An electrical fitting, comprising:
a fitting body comprising a hollow cavity extending from a first threaded end to a second threaded end, the first threaded end having a larger circumference than the second threaded end, the hollow cavity including a sloped opening extending along at least a portion of a length of the hollow cavity that is tapered to narrow a diameter of the hollow cavity in a direction towards the second threaded end;
an inner sleeve member that comprises a tubular housing, the tubular housing including one or more spring arm members directed towards an interior of the inner sleeve member, the inner sleeve member being retained within the hollow cavity of the fitting body;
a nested grommet comprising an inner grommet portion and an outer grommet portion, the inner grommet portion including a body configured to at least partially nest within at least a portion of a bore of the outer grommet portion; and
a fitting nut configured to be threaded onto the first threaded end;
wherein the nested grommet is interfaces with the fitting nut and the sloped opening to form a seal resulting from compression caused by threading the fitting nut about the first threaded end.

2. The electrical fitting of claim 1, wherein the bore of the outer grommet portion extends from a first circumferential end to a second circumferential end, the first circumferential end having a larger surface circumference than the second circumferential end such that the outer grommet portion forms a tapered frustoconical sleeve.

3. The electrical fitting of claim 2, wherein the inner grommet portion includes a circumferential flange positioned one end of the body of the inner grommet portion, the circumferential flange including a circumference that coincides with the larger surface circumference of the first circumferential end of the outer grommet portion.

4. The electrical fitting of claim 1, wherein the outer grommet portion includes an integral ring that includes a diameter that coincides with a diameter of the first circumferential end.

5. The electrical fitting of claim 1, wherein the body of the inner grommet portion is substantially cylindrical and includes a through-hole.

6. The electrical fitting of claim 1, wherein the inner grommet comprises a first material and the outer grommet comprises a second material different from the first material, wherein at least the second material is a compressible resilient material.

7. The electrical fitting of claim 1, wherein the nested grommet further comprises one or more intermediate grommet portions that include a body having a diameter that is less than a diameter of the bore of the outer grommet portion and greater than a diameter of the body of the inner grommet portion.

8. The electrical fitting of claim 1, wherein the bore of the outer grommet portion includes a length that extends from a first end to a second end, and a diameter of the bore is constant across the length.

9. The electrical fitting of claim 1, wherein the tubular housing includes a length extending from a first end to a second end, wherein the tubular housing includes two spring arm members with the two spring arm members being offset along the length of the tubular housing such that a respective end of one spring arm member of the two spring arm members is disposed at a different distance from the first end than another respective end of another spring arm member of the two spring arm members.

10. The electrical fitting of claim 1, wherein the inner grommet portion is slidingly removable from the outer grommet portion.

11. The electrical fitting of claim 1, wherein the inner grommet portion and the outer grommet portion both comprise a compressible resilient material.

12. A nested grommet, comprising:
an outer grommet portion comprising a bore extending from a first circumferential end to second circumferential end, the first circumferential end having a larger surface circumference than the second circumferential end, the first circumferential end having a larger surface circumference than the second circumferential end such that the outer grommet portion forms an outer surface that forms a tapered frustoconical sleeve; and
an inner grommet portion comprising a body sized to at least partially nest within the bore of the outer grommet portion.

13. The nested grommet of claim 12, wherein the inner grommet portion includes a circumferential flange positioned one end of the body of the inner grommet portion, the circumferential flange including a circumference that coincides with the larger surface circumference of the first circumferential end of the outer grommet portion.

14. The nested grommet of claim 13, wherein the outer grommet portion includes an integral ring that includes a diameter that coincides with a diameter of the first circumferential end.

15. The nested grommet of claim 12, wherein the body of the inner grommet portion is substantially cylindrical and includes a through-hole.

16. The nested grommet of claim 12, wherein the inner grommet comprises a first material and the outer grommet comprises a second material different from the first material, wherein at least the second material is a compressible resilient material.

17. The nested grommet of claim 12, wherein the nested grommet further comprises one or more intermediate grommet portions that include a body having a diameter that is less than a diameter of the bore of the outer grommet portion and greater than a diameter of the body of the inner grommet portion.

18. The nested grommet of claim 12, wherein the bore of the outer grommet portion includes a diameter that is constant.

19. The nested grommet of claim 12, wherein the inner grommet portion is slidingly removable from the outer grommet portion.

20. The nested grommet of claim 12, wherein the inner grommet portion and the outer grommet portion both comprise a compressible resilient material.
